(19) United States
(12) Patent Application Publication
(10) Pub. No.: US 2008/0298635 A1
(43) Pub. Date: Dec. 4, 2008

(54) Method for identifying images using fixtureless tracking and system for performing same

(76) Inventor: William M. West, New Milford, CT (US)

Correspondence Address: PITNEY BOWES INC.;35 WATERVIEW DRIVE, P.O. BOX 3000, MSC 26-22, SHELTON, CT, 06484-8000, US

(21) Appl. No.: 11/807,700

(22) Filed: May 29, 2007

(51) Int. Cl. G06K 9/00

(52) U.S. Cl. 382/101

(57) ABSTRACT

A method and system for fixtureless vision tracking of a target image for use by the vision system when processing subsequent sheets/documents in a sheet handling apparatus. A sheet of material is passed through the sheet handling system to acquire image data within a field of view of the initialization sheet. The acquired image is then filtered and stored/saved in a filtered image data file while an unfiltered image is also retained for the purposes of additional analysis. The filtered image is modified by an erosion technique to form blob images while the unfiltered image is substantially unchanged from the original optical image, i.e., retains the various character strings in their original form. The vision system then performs a dual tier analysis on the blob images and character strings to identify the target image. Additionally, the spatial location of the target image is determined to provide location data for processing subsequent sheet material. That is, the location data serves to rapidly locate the region of interest to identify and read the target image on the remaining sheets to be processed.

### TECHNICAL FIELD

The present invention relates to vision systems for optical character recognition, and, more particularly, to a method which identifies images/symbology within a defined field of view without the need for special fixtures/characters to identify/locate target images or symbology.

### BACKGROUND OF THE INVENTION

A mail insertion system or a “mailpiece inserter” is commonly employed for producing mailpieces intended for mass mail communications. Such mailpiece inserters are typically used by organizations such as banks, insurance companies and utility companies for producing a large volume of specific mail communications where the contents of each mailpiece are directed to a particular addressee. Also, other organizations, such as direct mailers, use mailpiece inserters for producing mass mailings where the contents of each mailpiece are substantially identical with respect to each addressee.

Due to the high cost of such mailpiece inserters, i.e., high investment in capital, it is becoming increasingly popular/profitable to provide mail communications services to others, i.e., as an independent business/service provider. That is, a service provider, having made an initial investment in a mailpiece inserter, can service customers with relatively infrequent mailing requirements, e.g., a real estate agency, insurance company or large business concern having a need to communicate with its customers/employees several times each year.

Typically, a stack of printed content material is provided by the customer to the service provider so that the service provider can compile and produce finished mailpieces, i.e., ready for mailing. The content material may additionally include a printed “scan code” or symbology to convey certain mailing instructions. Such scan codes are typically preprinted in the margins of the content material and read by the mailpiece insertion system to provide specific mailing instructions for mailpiece fabrication. For example, a scan code may communicate instructions that a mailpiece (i) include the next three sheets of the stacked content material, (ii) be folded in a particular configuration, e.g., C-, Z-, or V-shape, and/or (iii) be combined with other inserts, e.g., coupons, related literature, etc.

Additionally, as described in the Background of the Invention, a service provider may request that the customer include a special code or sequence number on the content material (typically near the mailing address) for its own internal tracking purposes. That is, in an effort to ensure quality assurance, the service provider may use these symbols/sequence numbers to ensure that no sheet of content material has been inadvertently overlooked or erroneously inserted into an envelope. The mailpiece inserter may be adapted with a machine vision system to read/interpret the code or sequence number. Generally, such vision systems or optical scanning devices are integrated at an upstream location to avoid conflict with other downstream inserter modules which may fold, add inserts, envelope, weigh, meter, and/or sort the mailpiece(s).

Inasmuch as mailpiece inserters produce thousands of mailpieces every hour, it will be appreciated that the rate of sheet production is extremely high. To maintain these high levels of sheet production, all of the inserter modules, including the vision system/optical scanning module, must operate flawlessly over the course of many print jobs. Difficulties commonly encountered with respect to the optical scanning module typically relate to misreading codes or other symbology due to (i) improper vision system set-up, (ii) shifting of the content material within the envelope, i.e., changing the relative position of fixtures within the window/field of view and/or (iii) the inability of the underlying control algorithms to properly locate, identify and read the images/symbols within the small allotment of time, i.e., as the code/symbology races by the scanning equipment.

To improve symbology/code read rates and/or the reliability thereof, additional time may be invested in vision system set-up. That is, the vision system may be adapted to include/run various back-up or redundant software algorithms to improve the probability of an accurate symbology/code read. Unfortunately, as more time is invested in vision system set-up, (i.e., to avoid misreads), the fiscal advantages of performing the mailing service can suffer greatly or erased entirely.

A need, therefore, exists for a rapid and reliable method for identifying target images within a field of view without the need for costly vision system set-up and/or errors associated therewith.

### SUMMARY OF THE INVENTION

A method and system is provided for fixtureless vision tracking of a target image for use by the vision system when processing subsequent sheets/documents in a sheet handling apparatus. A sheet of material is passed through the sheet handling system to acquire image data within a field of view of the initialization sheet. The acquired image is then filtered and stored/saved in a filtered image data file while an original unfiltered image is also retained for the purposes of additional analysis. The filtered image is modified by an erosion technique to form blob images while the unfiltered image is substantially unchanged from the original optical image, i.e., retains the various character strings in their original form. The vision system then performs a dual tier analysis on the blob images and character strings to identify the target image. Additionally, the spatial location of the target image is determined to provide location data for processing subsequent sheet material. That is, the location data serves to rapidly locate the region of interest to identify and read the target image on the remaining sheets to be processed.

### BRIEF DESCRIPTION OF THE DRAWINGS

The accompanying drawings illustrate presently preferred embodiments of the invention, and, together with the general description given above and the detailed description given below, serve to explain the principles of the invention. As shown throughout the drawings, like reference numerals designate like or corresponding parts.

FIG. 1 is a schematic diagram of a sheet handling system/mailpiece inserter having a fixtureless vision tracking (FVT) system according to the present invention for identifying a target image within a field of view.

FIGS. 2a and 2b depict unfiltered and filtered images, respectively, acquired by the FVT system of the present invention wherein the filtered image of FIG. 2b includes a plurality of blob images produced by eroding the unfiltered image of FIG. 2a.

FIGS. 3a, 3b and 3c depict the method steps for performing fixtureless vision tracking to identify the target image according to the present invention.

FIG. 4a depicts several pattern models for comparison against various images filtered by the vision system and for determining whether at least one of the filtered images is a candidate for identification as the target image.

FIG. 4b is a table pictorially depicting the various filtered images of a field of view together with an analysis of the percentage match value between a selected pattern model and each filtered image.

FIG. 5 depicts the field of view acquired by the vision system after being modified by a neighbor filter and illustrates the method for identifying/locating a region of interest within the field of view to acquire a target image.

### BEST MODE TO CARRY OUT THE INVENTION

The inventive method and system for printing and producing mailpieces is described in the context of a mailpiece inserter system. Further, the invention is described in the context of a DI900 Model Mailpiece Inserter, i.e., a mailpiece creation system produced by Pitney Bowes Inc., located in Stamford, State of Conn., USA, though, the inventive subject matter may be employed in any sheet handling apparatus, mailpiece inserter and/or in combination with print manager software algorithms used in the printing/creation of mailpieces.

Inasmuch as many sheet handling systems, such as the mailpiece inserters described above, process thousands of sheets per unit of time (e.g., per hour), vision systems have a relatively small window of time to acquire, process, and read image data within a field of view. For mailpiece inserters, the vision system may have as little as sixty (60) to one-hundred twenty (120) milliseconds to acquire and interpret image data captured by an optical scanning device or camera. This can be particularly difficult when performing multiple layers/tiers of analysis to identify and read a target symbology which may closely resemble other images within the same field of view. Consequently, the software algorithms controlling such vision systems must execute nearly flawlessly to achieve the reliability standards commonly required of such systems. For example, a typical mailpiece inserter must accurately read nine-thousand, nine-hundred and ninety-nine out (9,999) out of every ten-thousand (10,000) records without error to meet the read rates/requirements. Further, to avoid misreads, system set-up and initialization must be performed with great care and a high degree of accuracy.

A typical vision system optically scans the face surface of a printed document and captures images of regions and sub-regions thereof. The first or principle region acquired by the vision system is analogous to a “snapshot” of a conventional camera and, for the purposes of this description, is referred to as the “field of view”. A sub-region within the field of view is a “region of interest (ROI)”. Generally, vision systems having an optical scan resolution of at least 640×480, image acquisition time of at least 30 ms, with filtering finding and OCR decoding times of 70 ms, will have adequate performance to achieve read rates consistent/commensurate with high output material handling systems such as mailpiece inserters, sorters and other mailing/printing apparatus.

In the broadest sense of the invention, a first or initialization sheet is passed through the sheet handling system or mailpiece inserter to acquire image data for use in processing subsequent sheet material(s). The acquired image is filtered and stored/saved in a filtered image data file while an unfiltered image is retained for the purposes of additional analysis. The filtered image is modified by an erosion technique to form blob images, while the unfiltered image is substantially unchanged from the original optical image, i.e., retains the various character strings in their original form. The vision system then performs a layered or dual tier analysis on the blob images and character strings.

In a first tier analysis, the blob images of the filtered image are compared to pattern models. When one of the blob images yields a maximum threshold match value, i.e., identified as a candidate blob image, the vision system progresses to a second tier analysis on the individual characters of the corresponding character string, i.e., the string of characters corresponding to the candidate blob image.

In the second tier analysis, the individual characters are compared to a set of predefined machine readable characters. When the corresponding character string yields a maximum threshold match value, the vision system identifies the candidate blob/character string as the target image for processing subsequent sheets of material. Identification is typically performed by spatially locating the region of interest so that acquisition and analysis on subsequent sheets can be performed reliably and expeditiously. That is, the spatial location of the target image is determined to provide location data for processing subsequent sheet material. The location data serves to rapidly locate the region of interest to identify and read the target image on the remaining sheets to be processed.

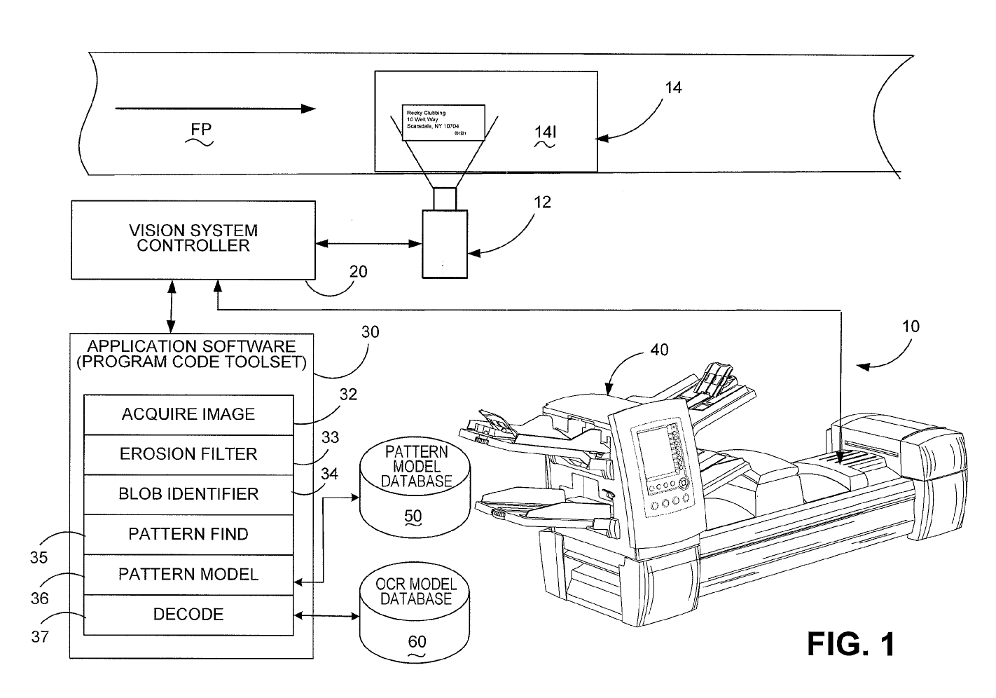

In FIG. 1, the vision system 10 comprises an optical sensor or camera 12 for acquiring images of the printed document 14, a system controller or processor 20 for controlling the optical sensor/camera 12, and application software or program code 30 for acquiring, storing and manipulating the image data acquired by the optical sensor/camera 12. In the described embodiment, the vision system 10 is a Cognex Insight Model 5400, although other vision systems may be employed.

The application software or program code 30 comprises a plurality of conventional tools which are employed in an unconventional manner to yield the fixtureless tracking system and method of the present invention. The principle software application tools employed include: an acquisition tool 32, an erosion filter 33, a blob identifier 34, a pattern find 35, a pattern model 36 and decoding tool 37. Such software application tools are available from Cognex, a company specializing in machine vision systems, located in Natick, Mass., USA, under the tradename “Insight Vision Systems”. The following table lists and describes the various application software tools which control and perform the operations of the vision system. It may be useful to refer back to the table throughout the description, i.e., as certain application tools are discussed.

TABLE

| VISION SYSTEM | |
|---|---|
| APPLICATION/TOOLS | TOOL DESCRIPTION |
| ACQUIRE IMAGE | Captures a digital image within a “field of view” or “region of |
| | interest” on the face surface of a printed document. The vision |
| | system optical scanner or camera responds to a trigger (e.g., the |
| | leading edge of the document passing a photocell) to take a |
| | “snapshot” at a particular location along/on the document. The |
| | digital data is transferred to the vision system processing memory. |
| NEIGHBOR (EROSION) | A filtering operation which produces an eroded or “blob” image. |
| FILTER | The blob image is produced by modifying a set of pixels from the |
| | original input image defined by a finite local “neighborhood.” The |
| | neighborhood is typically rectangular in shape and has a height |
| | dimension equal to a number of rows and a width dimension equal |
| | to a number of columns. When performing a grey-scale erosion, |
| | pixels in the eroded image result from a grey-scale minimization |
| | taken over a corresponding neighborhood in the input image. This |
| | operation shrinks bright features and grows dark features by the |
| | size of the pixel neighborhood. |
| PATTERN MODEL | A stored model of a geometric shape corresponding to the |
| | geometric shape of an image, whether a filtered/eroded image or |
| | a string of machine readable characters. The pattern model may |
| | be predefined by the user/operator or “trained” during operation of |
| | the vision system. With respect to the former, the inventive |
| | method employs predefined pattern models in a first tier analysis |
| | as a baseline for comparison against the geometric shape of an |
| | eroded image. With respect to training the vision system, certain |
| | predefined parameters and assumptions can be made (e.g., that a |
| | target image has a certain number of digits and employs a |
| | predefined font type/style), such that new or candidate pattern |
| | models can be stored for subsequent retrieval. That is, trained |
| | pattern models may be stored and used when processing |
| | subsequent sheets of material, i.e., following an initialization sheet. |
| OPTICAL CHARACTER | A conventional operation wherein an image comprising a string of |
| RECOGNITION (OCR) | machine readable characters is compared to character models |
| FILTER | (much like the pattern models described above) in a user-trained |
| | font for decoding/reading the image. Character models which |
| | yield the highest match score determine the identity of the target |
| | character. |
| IMAGE (BLOB) | This software tool extracts filtered/blob data (i.e., indicative of the |
| EXTRACTION | eroded or blob image) from a region of interest within the vision |
| | system field of view. The operation scans the region of interest to |
| | classify pixels as either being part of the object or background |
| | surrounding the object. An analysis is performed with respect to |
| | each of the connected pixel regions and reported to the vision |
| | system processor in a “blob data structure array”. |
| PATTERN FIND | Using the pattern models, character models and blob extraction |
| (LOCATION) | tools mentioned above, blob and/or OCR images are searched to |
| | determine when maximum threshold match scores are achieved. |
| | A two-tiered analysis is performed, a first associated with |
| | comparing filtered/blob images against a select group of |
| | predefined or trained pattern models and a second associated |
| | with comparing the unfiltered/OCR image (the original string of |
| | machine readable characters) against a predefined set of |
| | character models comprising user-trained fonts. Once the target |
| | image is identified, its location within the field of view is |
| | determined and reported for subsequent use by the sheet |
| | handling system, i.e., for processing subsequent sheets of |
| | material. |

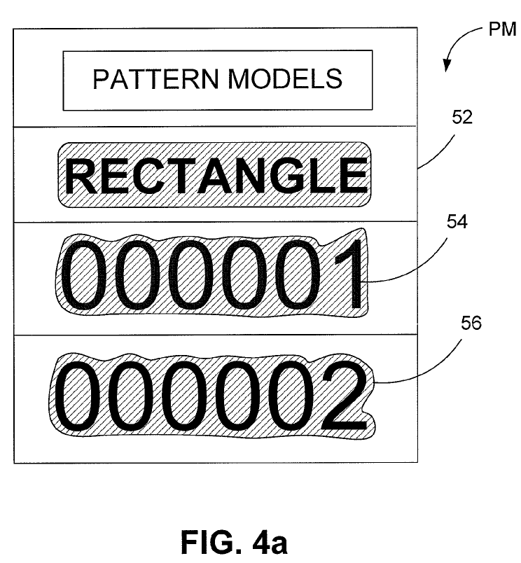

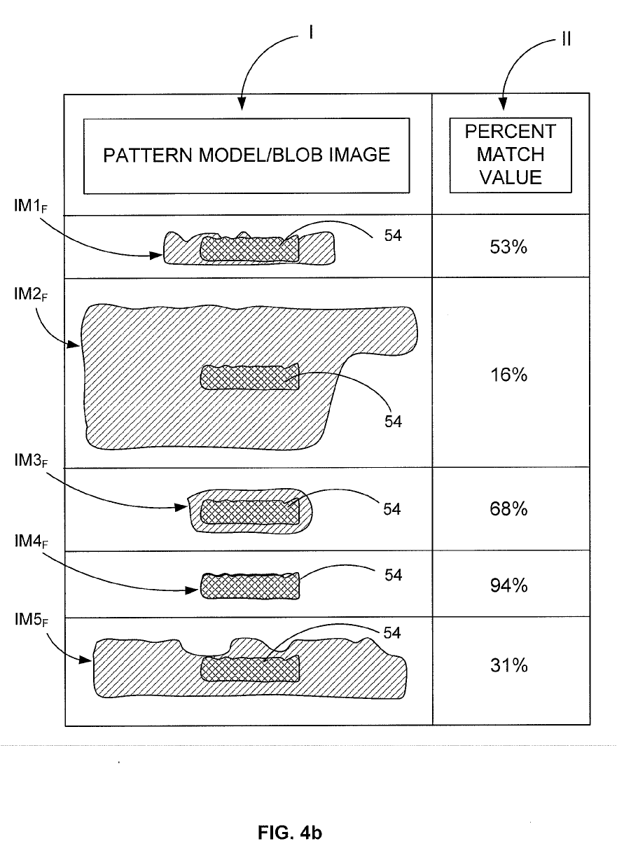

In FIGS. 1-3b, after selecting the particular job run for processing, the various application software tools are loaded in step A. The toolset includes the application software identified and defined in the Table above. In Step B, the camera 12, in combination with the acquire image toolset 33, optically scans the initialization sheet 141 to acquire a digital image of the prescribed field of view FV. That is, the initialization sheet 141 is passed along the paper or feed path FP of the sheet handling system 40 (see FIG. 1). While the initialization sheet 141 is typically the first sheet containing the target image, other sheets, in advance of the initialization sheet 141, may be used for system test or set-up. Hence, the initialization sheet need not be the first sheet of the mailpiece content material. In the described embodiment, the target image TI (see FIG. 4a) will typically be a multi-digit image, e.g., a sequence number, used for tracking the mailpiece job during processing. For example, the target image TI may be a five-digit sequence number from 00001 to 100,000 to track the processing of ten-thousand sheets of content material during a particular mailpiece job run. Generally, the target image TI is situated in isolation, i.e., with white space surrounding the image to facilitate identification, location and tracking. To further facilitate identification, the sequence number may be printed in a unique machine readable font such as in an OCR “A” or OCR “B” type font. OCR A & B fonts were developed as industry standards to improve read performance, i.e., mitigate misreads between similar characters.

More specifically, the sheet handling system 40 is equipped with a triggering mechanism such as a photocell disposed along the feed path. As the leading edge passes the photocell, a signal triggers the camera 12 to image the sheet 141, i.e., take a snapshot of the field of view. Inasmuch as the speed of the initialization sheet is known and substantially constant, the location of the field of view, i.e., its location relative to the leading edge, can be determined with a high degree of precision.

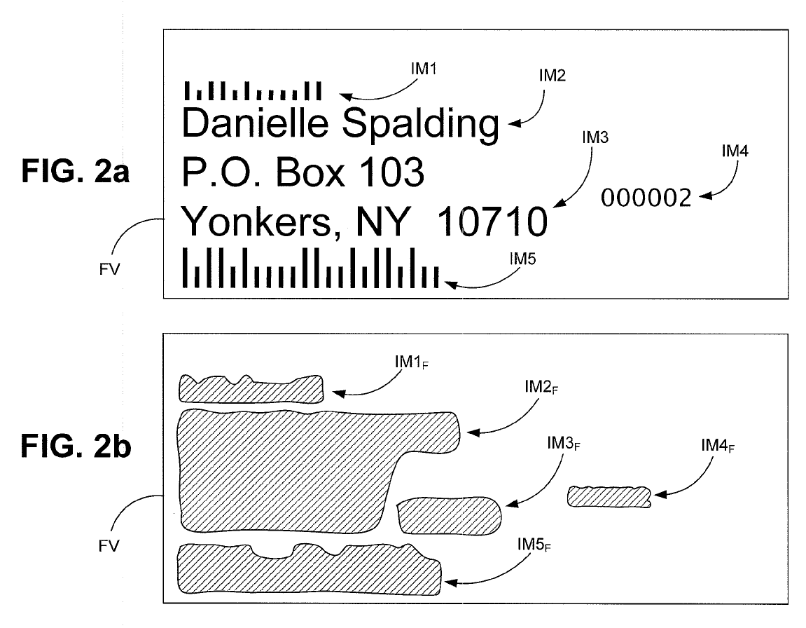

In step C, the vision system processor/controller 20 stores the various images IM contained within the field of view FV. In the described embodiment, the various images include an address code IM1, a customer name & destination address IM2, a zip code IM3, a target image IM4 and a planet code IM5, or other bar code symbology. While a target image IM4 is identified in the acquired image of FIG. 2a, it should be appreciated that the various images are only “potential images” for consideration until further analysis is performed in accordance with the teachings of the present invention. More specifically, the optical images are converted to digital images and stored in the processor memory. The scanned images IM will generally comprise strings of text, though they may contain any string of characters, e.g., user-trained fonts, character models or other machine readable characters, which are recognizable by machine vision apparatus.

In step D, the images IM1-IM5 are filtered by the neighbor filter application tool to produce blob images IM1_{F}-IM5_{F} (FIG. 2b) having a characteristic geometric shape. More specifically, each blob image IM1_{F}-IM5_{F} is produced by modifying or eroding the pixels of the originally acquired image. Inasmuch as the concepts and mathematics for eroding pixels to obtain blob images is well-known in the art, the underlying algorithms for performing this function will not be described. Suffice to say that the pixels are expanded or modified within a predefined two-dimensional “neighborhood”, e.g., a neighborhood having a height and width dimension, to blend/connect the pixels into a substantially continuous blob image. Stated another way, the filtering operation minimizes bright features and grows dark features of the original input image by the size of the predefined pixel neighborhood. While the specific erosion technique is well-known in the art and various “off-the-shelf” application software can be employed, it is important to appreciate that the blob images discussed herein are obtained for the purpose of rapidly acquiring a geometric shape and comparing that shape to a predefined pattern model or previously trained pattern model. In contrast, erosion filtering is typically performed for the purpose of enlarging the dark regions of an image to identify defects in an inspection process. Then a blob tool would be used to verify that the number of defects identified as blobs is within an acceptable tolerance.

In step E, the first tier analysis is initiated by extracting the various blob images, i.e., using the blob extraction tool, and comparing the blob images IM1_{F}-IM5_{F} to one or more predefined pattern models PM. In the context used herein, a pattern model PM is a stored model having a geometric shape corresponding to the geometric shape of an image whether the image is a blob image or a conventional machine readable character such as the digits “0” or “2”. More specifically, the pattern model data is loaded from the pattern model database 50 in step E1. Examples of several pattern models PM which may be stored in the pattern model database 50 are depicted in FIG. 4a. Therein, stored pattern models may include a predefined rectangular pattern model 52, and trained pattern models 54, 56 indicative of sequence numbers 000001 and 000002, respectively.

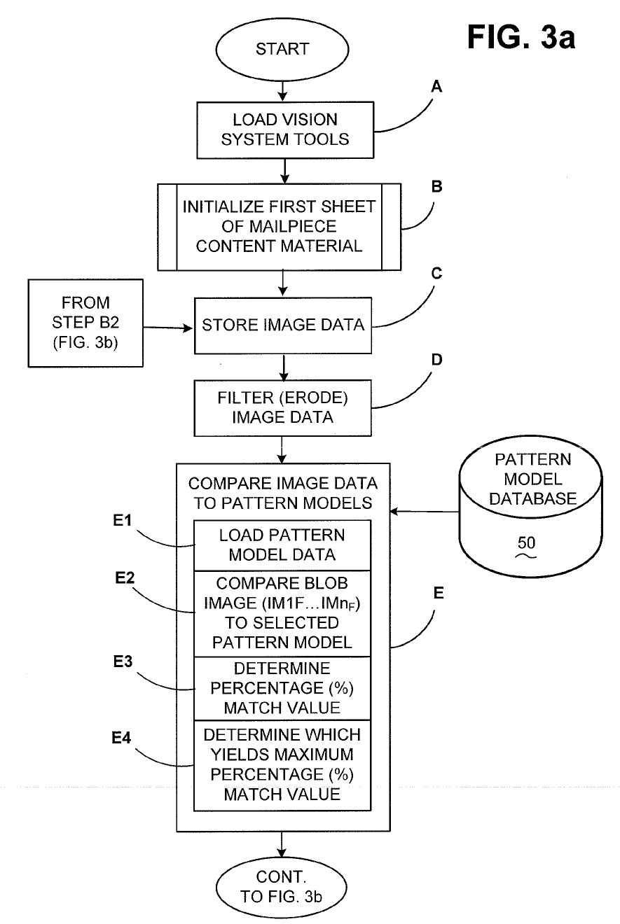

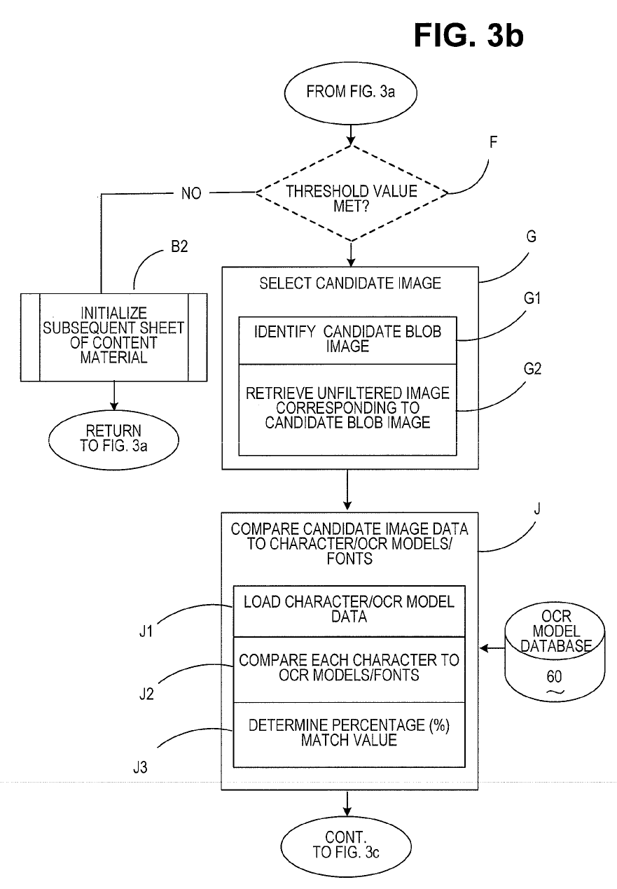

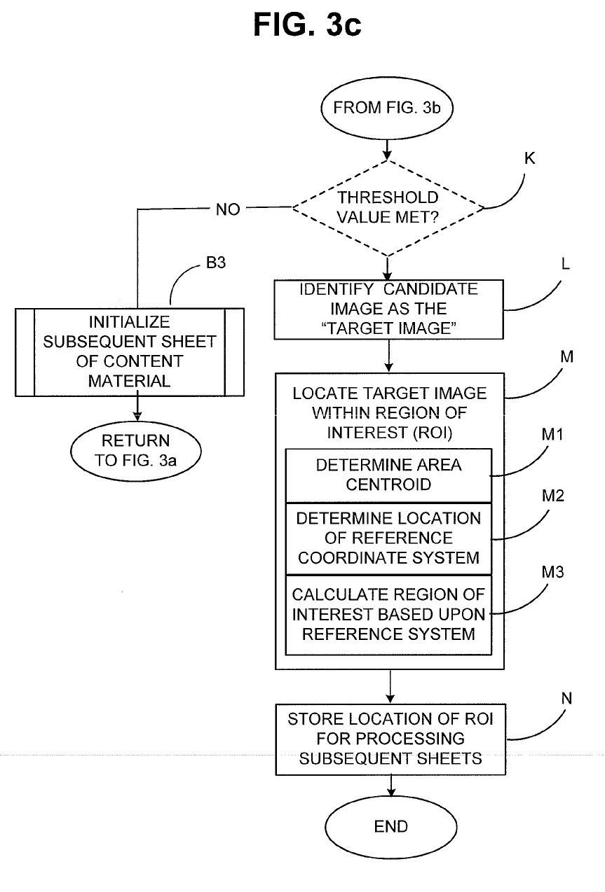

In step E2, the characteristic geometric shape of each of the blob images IM1_{F}-IM5_{F} is compared to the shape of any available pattern models which may exist in a pattern model database 50 (seen in FIGS. 1 and 3). This operation may be viewed as one which overlays each of the blob images IM1F . . . IMn_{F}, one-by-one, upon the pattern model to examine the commonalty and/or differences therebetween. Thereafter, in step E3, the percent (%) match value is calculated.

To better understand the comparison between a pattern model and each of the blob images IM1_{F}-IM5_{F}, reference is made to FIG. 4b. In column I thereof, each of the blob images IM1_{F}-IM5_{F} is overlaid by the pattern model 54 (see FIG. 4a) indicative of a sequence number 000001. In column II, the percent match value of each is given, which is essentially the number of pixels, expressed as a percentage of the total, that both the pattern model 54 and respective one of the blob images IM1_{F}-IM5_{F} share or have in common. This can be seen pictorially by examining the pixels falling beyond or within the bounds of the geometry, i.e., the peripheral shape of the pattern model 54.

In step E4, the blob images are evaluated to determine which yields the maximum percentage (%) match value. Returning to the exemplary embodiment of FIG. 4b, an examination of the percentage match values listed in column 11 thereof, reveals that blob image IM4_{F} yields the highest or maximum value. Before concluding, however, that the blob image IM4_{F} is the most likely candidate to be identified as the target image, in step F, a requirement to meet a threshold percentage match value may also be introduced and/or used for evaluation purposes. This evaluation may be performed to ensure that the geometric similarity between one of the blob images IM1_{F}-IM5_{F} and the pattern model PM meets a minimum threshold or standard. For example, a threshold percentage match value of eighty-five percent (85%) may be established to ensure a reasonable degree of confidence that subsequent analysis, in a second tier, will accurately or reliably identify the target image TI. If none of the blob images IM1_{F}-IM5_{F} meet the threshold match value, then another sheet of content material may be initialized in step B2 in a subsequent attempt to set-up the fixtureless tracking operation.

In the described embodiment, the blob image IM4_{F} yields a percentage match value of ninety-four percent (94%), which is a maximum value compared to the other blob images IM1_{F}, IM2_{F}, IM3_{F}, IM5_{F} and is greater than the minimum threshold percentage match value of eighty-five percent (85%). In step G, the image which meets the established criteria is selected as the “candidate image” for subsequent analysis. More specifically, the candidate image is the unfiltered image or original “OCR” version of the blob image IM4_{F} which has met the foregoing criteria. Consequently, step G may be viewed as including a first step G1, associated with identifying which of the blob images IM1_{F}-IM5_{F} exhibits or yields the maximum percentage match value and/or meets the established minimum threshold percentage match value, and a second step G2, associated with retrieving the corresponding unfiltered or OCR image of the blob image identified in step G1.

In step J, the candidate image IM4 corresponding to the blob image IM4_{F} is evaluated in the second tier analysis. This step invokes the use of the Optical Character Recognition (OCR) filter and proceeds in a manner similar to any conventional Optical Character Recognition (OCR) decoding algorithm. More specifically, in step J1, a database or library 60 of character models/OCR fonts is accessed and, in step J2, each character of the character string is evaluated against the character models/OCR fonts. That is, the image, which comprises a character string of discrete machine readable characters, is broken down such that each character may be compared to the character models (similar to the pattern models discussed hereinbefore). Typically, these OCR fonts will employ industry standard font types such as OCR A/OCR B fonts. In step J3, each character of the respective character string is examined to calculate the percentage match value.

While the examination of the various blob images IM1_{F}-IM5_{F} described above include an examination of a maximum percentage match value, the evaluation of each character string does not invoke or have the same requirement. That is, since one character within a string is not compared to another character within the same string, there is no need to determine a maximum percentage match value—but only a predefined threshold match value. Accordingly, a step corresponding to one which determines a maximum percentage match value is not required.

In step K, a determination is made concerning whether all of the characters yield a threshold percentage match value. For example, it may be required that each character yield a ninety percent (90%) match value, i.e., with respect to one of the character fonts, before determining that the character is an affirmative match.

When all characters of the string have been determined to exceed the threshold percentage match value, then the candidate image may then be identified in step L as the target image or image of interest. If, on the other hand, all characters within the string do not meet the threshold match value, then another sheet of content material may be initialized in step B3 in a subsequent attempt to set-up the fixtureless tracking operation.

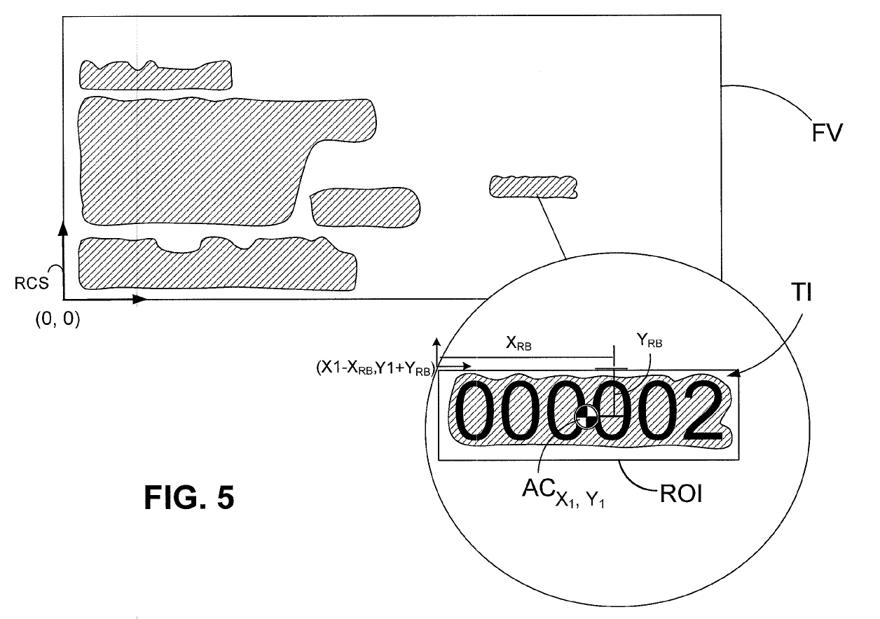

Having identified the target image TI in step L, the location of the target image must be accurately assessed, in step M, to ensure that, with respect to the processing of subsequent sheets of material, the vision system can rapidly acquire and read the target image TI. More specifically, in step Ml and also referring to FIG. 5, the area centroid AC of the filtered/blob image IM4_{F} and its location AC_{(X1, Y1)} relative to a reference coordinate system RCS within the field of view FV is determined. In the described embodiment, the reference coordinate system RCS is located at the lower left-hand corner of the field of view, though the coordinate system RCS may be at any convenient location.

In step M2, offset dimensions X_{RC}, Y_{RC} from the area centroid AC in the X and Y directions are calculated to establish a reference location within the field of view FV. Thereafter, in step M3, a region of interest ROI circumscribes the target image TI and is slightly oversized relative to the target image TI. In the described embodiment, the bounded region of interest ROI is approximately ten percent (10%) larger than the periphery of the target image TI. Further, the general shape of the region of interest ROI is based the geometric shape of the target image TI filtered image. Finally, in step N, the image data associated with the location and geometry of the bounded region of interest ROI is stored for use by the vision system 10. Thereafter, vision system 10 will use this image data to rapidly and reliably locate the region of interest and target image when processing subsequent sheets of material.

While the invention has principally been described in the context of various method steps for performing various unique functions, the invention is equally well-described as a system or apparatus, e.g., a mailpiece inserter, for performing the various method steps. In fact, all of the elements have been described while discussing the method including the vision system 10, a system controller 20 and the application software/program code toolset 30 for operating the vision system and controller 20.

Inasmuch the method and system are so closely aligned, there is little benefit to describe the invention in the context of system language, though, it should be appreciated that the invention is intended to embrace sheet handling equipment and mailpiece inserters having the unique combination of software tools and algorithms for performing fixtureless tracking. Furthermore, the invention is intended to cover vision systems adapted for use in combination with such sheet handling apparatus. Moreover, the invention is applicable to any vision system for rapidly identifying target images within a field of view.

It is to be understood that the present invention is not to be considered as limited to the specific embodiments described above and shown in the accompanying drawings. The illustrations merely show the best mode presently contemplated for carrying out the invention, and which is susceptible to such changes as may be obvious to one skilled in the art. The invention is intended to cover all such variations, modifications and equivalents thereof as may be deemed to be within the scope of the claims appended hereto.

1. A method for identifying a target image used in a sheet handling system, the method comprising the steps of:
scanning a sheet of material to be processed by the sheet handling system to acquire a plurality of images, each of the images comprising a string of machine readable characters;
filtering the images to determine a characteristic geometric shape for each image;
determining when a filtered image yields a maximum percentage match value by comparing its geometric shape to a predefined pattern model;
determining when an image corresponding to the filtered image yields a threshold match value by comparing its string of machine readable characters to a set of predefined machine readable characters; and
identifying the corresponding candidate image as the target image for processing subsequent sheet material.

2. The method according to claim 1 further comprising the step of determining when the one of the filtered images yields a threshold percentage match value when compared to the pattern models.

3. The method according to claim 1 further comprising the steps of:
determining an area centroid of the filtered image associated with the target image;
calculating an offset from the area centroid in two dimensions to establish a reference location within the field of view;
determining a bounded region of interest based upon the reference location and the geometric shape of the target image; and
storing data associated with the location and geometry of the bounded region of interest for use by the vision system when processing subsequent sheets of material.

4. The method according to claim 1 wherein the step of filtering the image includes a grey-scale erosion of image pixels within a finite pixel neighborhood.

5. The method according to claim 1 further comprising the step of storing image data associated with new pattern models in a pattern model database upon identifying a target image.

6. The method according to claim 3 wherein the region of interest is oversized relative to the filtered image.

7. The method according to claim 1 wherein the scanning step includes the step of acquiring an image within a field of view of an initialization sheet of the mailpiece job run.

8. A mailpiece inserter for processing sheet material used in the fabrication of mailpieces, comprising:
a conveyor system for transporting the sheet material along a feed path; and
a vision system including a camera disposed proximal to the conveyor system for capturing images on the face of the sheet material as it traverses the feed path, a vision system processor for performing various computational operations and program code for controlling the operation of the camera and processor, the program code furthermore, operative to:
identify the location of a field of view acquired by the camera,
filter the images to determine a characteristic geometric shape for each image;
compare the filtered images to at least one pattern model having a characteristic geometric shape;
determine when a filtered image yields a maximum percentage match value upon comparison to the characteristic geometric shape of the pattern model;
compare each of the characters associated with a candidate image corresponding to the filtered image to a set of predefined machine readable characters;
determine when all of the characters associated with the candidate image yields a threshold match value upon comparison to the machine readable characters; and
identify the candidate image as a target image for processing subsequent sheets of material.

9. The mailpiece inserter according to claim 8 wherein the program code is operative to determine when the one of the blob images yields a threshold percentage match value when compared to the available predefined pattern models.

10. The mailpiece inserter according to claim 8 wherein the program code is operative to:
determine an area centroid of the filtered image associated with the target image;
calculate an offset from the area centroid in two dimensions to establish a reference location within the field of view;
determine a bounded region of interest based upon the reference location and the geometric shape of the target image; and
store data associated with the location and geometry of the bounded region of interest for use by the vision system when processing subsequent sheets of material.

11. A method for identifying a target image used in a sheet handling system, the method comprising the steps of:
scanning an initialization sheet of material to be processed by the sheet handling system;
acquiring a plurality of images within a field of view of the initialization sheet, each of the images comprising a string of machine readable characters;
filtering the images within the field of view to define a plurality of blob images, each of the blob images producing a geometric shape;
comparing the geometric shape of each blob image to available pattern models stored in a data file of the vision system;
determining when one of the blob images yields a maximum percentage match value when compared to the available predefined pattern models and identifying the blob image as a candidate image;
comparing the machine readable characters of the image corresponding to the candidate image to a set of predefined machine readable characters stored in the vision system;
determining whether the string of machine readable characters yields a threshold percentage match value when compared to the predefined machine readable characters; and
identifying the candidate image as the target image for processing subsequent sheet material.

12. The method according to claim 1 1 further comprising the step of determining when the one of the blob images yields a threshold percentage match value when compared to the available predefined pattern models.

13. The method according to claim 11 further comprising the steps of:
determining an area centroid of the filtered image associated with the target image;
calculating an offset from the area centroid in two dimensions to establish a reference location within the field of view;
determining a bounded region of interest based upon the reference location and the geometric shape of the target image; and
storing data associated with the location and geometry of the bounded region of interest for use by the vision system when processing subsequent sheets of material.

14. The method according to claim 11 wherein the step of filtering the image includes a grey-scale erosion of image pixels within a finite pixel neighborhood.

15. The method according to claim 11 further comprising the step of storing image data associated with new pattern models in a pattern model database upon identifying a target image.

16. The method according to claim 13 wherein the region of interest is oversized relative to the filtered image.

17. The method according to claim 11 wherein the scanning step includes the step of acquiring an image within a field of view of an initialization sheet of the mailpiece job run.
